(19) United States
(12) Patent Application Publication
(10) Pub. No.: US 2016/0025630 A1
(43) Pub. Date: Jan. 28, 2016

(54) ANALYTICAL INSTRUMENT SYSTEMS

(71) Applicant: NVS TECHNOLOGIES, INC., Menlo Park, CA (US)

(72) Inventors: Morten Jensen, Saratoga, CA (US); Nimisha Srivastava, Mountain View, CA (US); Min Yue, Belmont, CA (US); Aashish Priye, Bryan, TX (US); Robert Nagle, Mountain View, CA (US)

(21) Appl. No.: 14/776,567

(22) PCT Filed: Mar. 14, 2014
(86) PCT No.: PCT/US2014/029412

§ 371 Date: Sep. 14, 2015

Related U.S. Application Data
(60) Provisional application No. 61/793,388, filed on Mar. 15, 2013.

(51) Int. Cl. G01N 21/64

(52) U.S. Cl. CPC G01N 21/6428; G01N 2021/6432; G01N 2201/061; G01N 2201/062; G01N 2201/0638

(57) ABSTRACT

The invention provides optical instrument systems and methods for analyzing signals from biological arrays, and performing analytical amplification reactions for identifying the presence or absence of a target nucleic acid sequence in a sample to be analyzed.

### CROSS-REFERENCE TO RELATED APPLICATIONS

This application claims priority to U.S. Provisional Patent Application No. 61/793,388, filed Mar. 15, 2013, the full disclosure of which is hereby incorporated by reference in its entirety for all purposes.

### STATEMENT REGARDING FEDERALLY SPONSORED RESEARCH

This invention was made with support of a U.S. Dept. of Homeland Security grant, Contract Number HSHQDC-10-C-00053. The government has certain rights in the invention.

### BACKGROUND OF THE INVENTION

The individual identification, distinction and/or quantitation of different optical signals from a collection of such signals is of major importance in a number of different fields. Of particular note is the use of multiplexed analytical operations, e.g., nucleic acid analysis, biological assays, chemical assays, etc., which rely on optical signaling. A number of analytical systems have been developed and commercialized for collecting, recording and analyzing optical signal data from biological, or chemical assay arrays, including, e.g., nucleic acid array scanners, multiplexed nucleic acid sequencing systems, and the like.

By way of example, nucleic acid arrays have been widely used for identifying the presence of one or more target nucleic acids in a sample. In particular, in typical arrays, a planar substrate is provided with different nucleic acid probe sequences bound in positionally distinct areas of the substrate surface where the identity of the bound entity, or capture probe, as well as its position on the surface of the array is known. Each different capture probe identity is disposed within a discrete capture probe site or region, which includes a population of identical capture probes. A sample is subjected to an amplification reaction using primer sequences that are specific for a target nucleic acid sequence of interest, i.e., the sequence for which the sample is being tested. Typically, one or both of the primers may include a fluorescent or other labeling group. Following amplification, the resulting reaction mixture is contacted with the array. Where fluorescent signals appear on the array surface, it is indicative that the sequence complementary to the capture probe at that location was amplified, and thus, was present in the sample.

Reading fluorescent signals from these arrays has generally utilized a number of different types of systems. For example, early array reading instruments employed scanning fluorescent microscopes that rastered across the surface of the array and read the emitted fluorescence as a function of the position being scanned. Later fluorescent reader instruments utilized imaging optics and sensors to image an entire array at a time, thus speeding up the analysis process. Such systems have increased in complexity for a variety of different applications, including, e.g., diagnostic array systems, nucleic acid sequencing applications, see, e.g., Illumina HiSeq systems, PacBio RS systems, and the like.

While such systems are generally available, there exists a need to provide improvements to these systems that will reduce their complexity and enhance their functionality. The present invention addresses these and other needs.

### BRIEF SUMMARY OF THE INVENTION

The present invention is directed to analytical instrument systems and analysis methods that are useful in analyzing biological arrays. The preferred instruments of the system are capable of performing this analysis in the context of an operating amplification reaction process, e.g., RT-PCR processes. These systems include improvements in the optical train, thermal management, and reaction manipulation processes that the instruments apply to reaction vessels used.

In at least one aspect, the invention provides a detection system, comprising an excitation light source, a reaction vessel comprising an array of capture probe sites disposed upon it and which can produce one or more fluorescent signals in response to an excitation light, an image sensor, an optical train for transmitting excitation light from the excitation light source to the array and fluorescent signals from the array to the image sensor, one or more thermal control elements disposed in thermal communication with the reaction vessel, and a processor operably coupled to the one or more thermal control elements which can be used for subjecting contents of the reaction vessel to a thermal cycling profile (e.g., for thermal mixing of reagents, etc.). In some such embodiments, the nucleic acid array can optionally comprise one or more fluorescent probe (e.g., capture probe) and the fluorescence of the array can optionally be increased or decreased based on capture or detection of, e.g., nucleic acids by the fluorescent capture probe. In some embodiments of such aspect, the system can comprise wherein the optical train includes a focusing lens for focusing the fluorescent signals onto the image sensor, and an optical path length adjustment component between the focusing lens and the image sensor, e.g., a rotatable variable thickness disk. In embodiments comprising a rotatable variable thickness disk, such disk can comprise a transparent material selected from glass, quartz, fused silica, and a transparent polymer such as one or more of: selected from polymethylmethacrylate, poly(carbonate), poly(styrene), poly(ethersulfone), poly(aliphatic ether), halogenated poly(aliphatic ether), poly(aryl ether), halogenated poly(aryl ether), poly(amide), poly(imide), poly(ester)poly(acrylate), poly(methacrylate), poly(olefin), halogenated poly(olefin), poly(cyclic olefin), halogenated poly(cyclic olefin), and poly(vinyl alcohol). In some embodiments of such systems, at least one thermal control element can be a thermoelectric element disposed in an optical path between the excitation light source and the array and optionally have an optical aperture (e.g., comprising a transparent thermally conductive material) disposed within it for transmitting the excitation light to the array. For embodiments comprising an optical aperture having a transparent thermally conductive material within it, the thermally conductive material can comprise a thermal conductivity of at least 1 W/mK, preferably greater than 5 W/mK, and more preferably, greater than 10 W/mK, and in some cases greater than 100 W/mK or even 500 W/mK and/or can comprise a material selected from glass, sapphire, diamond, crystalline quartz, MgAl2O4 and ALON. In some embodiments of the invention, when the reaction vessel is positioned in thermal communication with the thermal control element having the aperture disposed therethrough, a gap of from about 1 to about 50 microns thick can be provided between the optically transparent, thermally conductive material and the reaction vessel. Furthermore, in some embodiments the one or more thermal control elements can create different temperature regions within the reaction vessel and thus apply a differential temperature across at least a portion of the reaction vessel. In embodiments having thermal control elements applying different temperature regions within the reaction vessel, the systems can comprise a processor that includes programming to apply different temperatures to the different temperature regions of the thermal control element(s) (and thus, to different regions of the reaction vessel). In some embodiments, the thermal control elements can cause thermal mixing of one or more components within the reaction vessel.

In some aspects, the invention comprises a method of detecting a nucleic acid amplification product by amplifying a target nucleic acid in a reaction mixture in the presence of a nucleic acid array; cooling the reaction mixture to a hybridization temperature in a hybridization step to permit hybridization of the amplification product to the array; subjecting the reaction mixture to convective mixing before or during the hybridization step; and, detecting amplification product that hybridizes to the array. In some such embodiments, the nucleic acid array can optionally comprise one or more fluorescent probe (e.g., capture probe) and the fluorescence of the array can optionally be increased or decreased based on capture or detection of, e.g., nucleic acids by the fluorescent capture probe.

### BRIEF DESCRIPTION OF THE DRAWINGS

FIG. 1 provides a schematic illustration of an exemplary assay format useful in conjunction with the systems and methods described herein.

FIG. 2 provides a schematic of an overall instrument system of the invention.

FIG. 3 provides an illustration of an exemplary sample holder component of an instrument system herein.

FIG. 4A shows a schematic illustration of an exemplary reaction vessel in conjunction with thermal control elements of a substrate holder portion of an instrument system. FIG. 4B shows a schematic illustration of convective mixing.

FIG. 5 illustrates an optics train portion of an instrument of the invention including an optical path length adjusting component.

FIGS. 6A and 6B provide a schematic illustration of sample distribution on an array with and without mixing of the analytes applied to the array, e.g., amplicons.

FIGS. 7A and 7B present a comparison of fluorescent signal data across an array during an amplification reaction both with and without mixing during amplification.

FIGS. 8A and 8B also present a comparison of fluorescent signal data across an array during an amplification reaction both with and without mixing during amplification.

FIG. 9 shows a schematic illustration of an exemplary assay method that can be used with the systems of the invention.

FIG. 10 shows the thermal mixing of reagents in a reaction vessel comprised within a system of the invention.

### DETAILED DESCRIPTION OF THE INVENTION

### I. Overview

The present invention is generally directed to analytical instruments, systems, and methods for performing biological and biochemical analyses. The instruments and systems of the invention are particularly suited for monitoring fluorescent signals that derive from targeted nucleic acid amplification reactions, and moreover, are typically suited for carrying out the underlying amplification processes as well. Thus, various embodiments of the systems of the invention include not only the detection capabilities, but also capabilities for carrying out the reactions of interest, e.g., thermal cycling as well as other operating parameters.

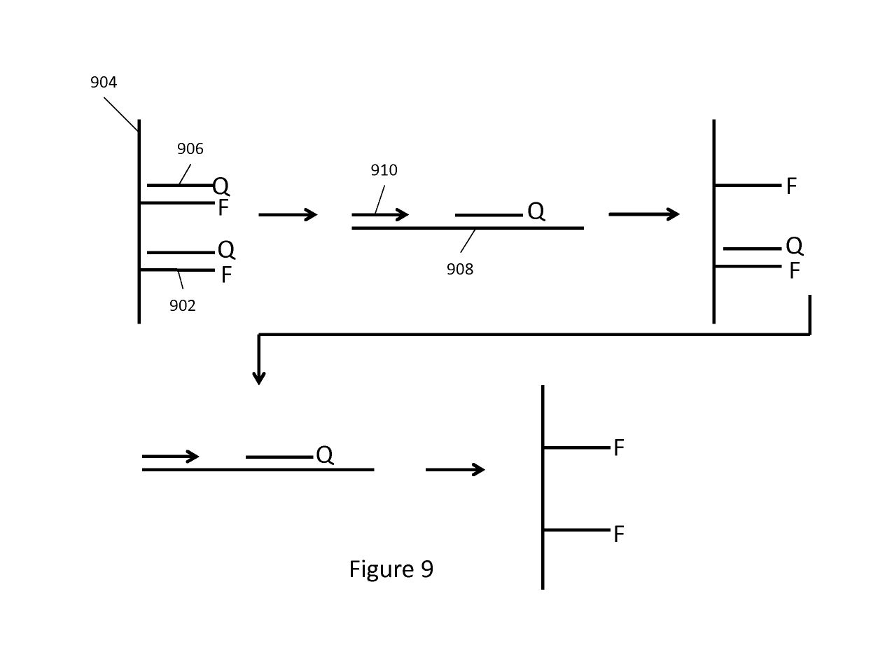

For purposes of discussion, various embodiments of the present invention are illustrated with reference to the assay methods described in, e.g., U.S. patent application Ser. No. 13/844,426, filed Mar. 15, 2013, which is incorporated herein by reference in its entirety for all purposes. A simplified process flow for such assays is shown in FIG. 9. As shown in FIG. 9, set of capture probes 902, each of which probes bears an associated fluorescent moiety or fluorophore (F), is immobilized upon the surface of substrate 904. Target specific probes 906 are also provided that are complementary both to capture probes 902 and a target nucleic acid sequence of interest. These target specific probes include an associated quencher moiety (Q). The positioning of the fluorophore F on capture probe 902 and the quencher Q on target specific probe 906, are selected such that when probes 902 and 906 are hybridized together, the quencher is positioned sufficiently proximal to the fluorophore as to quench its fluorescence when otherwise subjected to excitation illumination.

The above probes can be contacted with a sample material that is suspected of containing a target nucleic acid of interest, e.g., target sequence 908, and the target sequence is subjected to a PCR reaction process using a polymerase that includes, for example an inherent exonuclease activity. The PCR process can include multiple iterative melting, annealing, and extension reaction steps resulting in extension of appropriate primer 910 across target sequence 908. During each annealing step, at least some of target specific probes 906 will anneal to target sequence 908. As that target sequence is replicated by the polymerase during the extension reactions, target specific probes 906 that are hybridized to the target are digested by the exonuclease activity of the polymerase enzyme, thereby preventing them from hybridizing with the capture probes 902, and thus leaving the capture probes' associated fluorophores unquenched. An equilibrium will exist in a given reaction mixture for the target specific probe binding to either the capture probe or the target sequence. As the target sequence is amplified during the PCR reaction, that equilibrium would shift toward more of the target specific probe binding to the target, rather than binding to and quenching the labeled capture probe. As a result, that amplification would result in an increase in fluorescent signal.

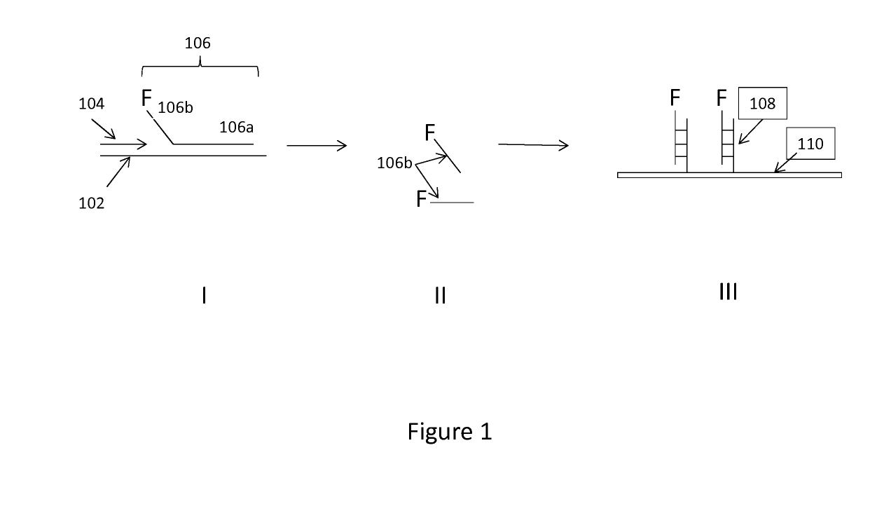

Additional and/or alternative assay methods such as those described in, e.g., U.S. patent application Ser. No. 13/399,872, which is incorporated herein by reference in its entirety for all purposes can also be used with various embodiments of the present invention. A simplified process flow for such assays is shown in FIG. 1. In brief, as shown in step I, a sample material is subjected to PCR amplification tailored to amplify one or more target nucleic acid sequences of interest 102, by providing amplification primer sequences 104 that are specific for amplifying the target sequence(s). The amplification reaction is also carried out in the presence of one or more probe sequences 106 that are also tailored to hybridize to the target sequence(s) of interest. In particular, the probe 106 is typically provided with a first portion 106a that is complementary to the target sequence, and a second labeled flap portion 106b that is not complementary to the target sequence. The labeled flap portion 106b is released upon amplification of the target sequence (step II) by virtue of the exonuclease activity of the polymerase enzyme used in amplification. The released flap portion 106b is captured by a complementary capture probe 108 sequence provided upon a solid support 110, e.g., a substrate surface. As noted previously, these capture probes are typically disposed in discrete regions or sites on the surface of the substrate, where each site includes a population of capture probes all having the same sequence and/or specificity. Accumulation of the labeled flap portion 106b at the surface of the solid support 110 indicates that the target sequence 102 is present and is being amplified. By using different flap portion sequences for different target sequences being assayed for, and by arraying different capture probes at different locations on a substrate that are complementary to those flap portion sequences, one can effectively detect the presence of multiple different target sequences in a single sample through a single amplification reaction process. Furthermore, because the labeled flap portion does not need to hybridize to the target, its sequence can be selected based upon the desired capture probe sequence or sequences on the substrate. As a result, a universal capture probe, or set of capture probes can be used to assay for any target sequence or sequences.

Although some of the methods capable of use with the systems/devices of the invention are described in terms of an accumulation of fluorescence at the substrate surface based upon either the release of a quenched probe from the surface or the binding of a labeled fluorescent probe to the surface (in either instance, e.g., via release or binding from/to a surface associated capture probe), it will be appreciated that a variety of signal formats are readily practicable. For example, in certain formats, accumulation of the flap portion of a probe can be detected through the quenching of signals associated with a fluorescent group on the surface bound capture probe by virtue of a quencher group on the flap portion of the probe. Likewise, capture probes may be configured to bind intact labeled target specific probes which are digested upon amplification of the target, thus resulting in a reduction of accumulated fluorescence, or in some cases, a reduction in quenching of a capture probe associated fluorophore by a quencher present on the target specific probe (e.g. as described above). Finally, alternative labeling arrangements, such as FRET based labeling, can be used to result in shifting of the fluorescent spectrum of the signals emanating from the supported capture probes. These various schemes are described in, e.g., co-pending U.S. Provisional patent application Ser. No. 13/399,872, filed Feb. 17, 2012, and U.S. Ser. No. 13/587,883, filed Aug. 16, 2012, the full disclosures of which are incorporated herein by reference in their entirety for all purposes.

In various embodiments, the above-described assay methods can be carried out within a reaction vessel or chamber that includes a detection region that comprises a planar nucleic acid detection array on at least one surface of the chamber, e.g., comprising one or more different capture probe regions. Each capture probe region can include a population of probes having a particular capture probe sequence immobilized within that region, so that such probes can hybridize with and localize any free complementary nucleic acids in solution, e.g., complementary labeled flap probe portions, within that region. Other probe regions may include probe populations having different nucleic acid sequences. The chamber can be configured to reduce signal background for signals detected from the array. For example, the chamber can be less than about 500 μm in depth in at least one dimension proximal to the array, e.g., between about 10 μm and about 200 μm in depth in at least one dimension proximal to the array. The chamber surface on which the array is formed, e.g., the detection region, is preferably fabricated from a transparent material through which optical, and particularly fluorescent signals can be collected. As such, this surface of the detection region can optionally be comprised of glass, quartz, or a transparent polymer, such as poly(styrene), poly(carbonate), poly(ethersulfone), poly(aliphatic ether), halogenated poly(aliphatic ether), poly(aryl ether), halogenated poly(aryl ether), poly(amide), poly(imide), poly(ester)poly(acrylate), poly(methacrylate), poly(olefin), halogenated poly(olefin), poly(cyclic olefin), halogenated poly(cyclic olefin), poly(vinyl alcohol), or the like.

In various embodiments, the capture nucleic acid probes on the array can be present at a non-rate limiting density during operation of the device. The array optionally can include a plurality of capture nucleic acid types, e.g., localized to spatially distinct regions of the array. For example, 5 or more different capture nucleic acid types can be present on the array, e.g., up to about 100 or more different types. Again, exemplary devices are described in detail in, e.g., U.S. patent application Ser. No. 13/587,883, previously incorporated herein by reference.

The capture nucleic acids are optionally coupled to a thermostable coating on the surface of the chamber, facilitating thermocycling of the array. Example coating(s) can optionally include: a chemically reactive group, an electrophilic group, an NHS ester, a tetra- or pentafluorophenyl ester, a mono- or dinitrophenyl ester, a thioester, an isocyanate, an isothiocyanate, an acyl azide, an epoxide, an aziridine, an aldehyde, an α,β-unsaturated ketone or amide comprising a vinyl ketone or a maleimide, an acyl halide, a sulfonyl halide, an imidate, a cyclic acid anhydride, a group active in a cycloaddition reaction, an alkene, a diene, an alkyne, an azide, or a combination thereof. Useful surface coatings are described in, e.g., U.S. patent application Ser. No. 13/769,123, which is incorporated herein by reference in its entirety for all purposes.

### II. General System Configuration

The present invention is generally directed to instruments, systems, and methods that are particularly useful for carrying out the above described amplification reactions and analyses. In particular, the systems implement the amplification reactions within reaction vessels, and then collect fluorescent signal data from the capture probe arrays integrated within those reaction vessels.

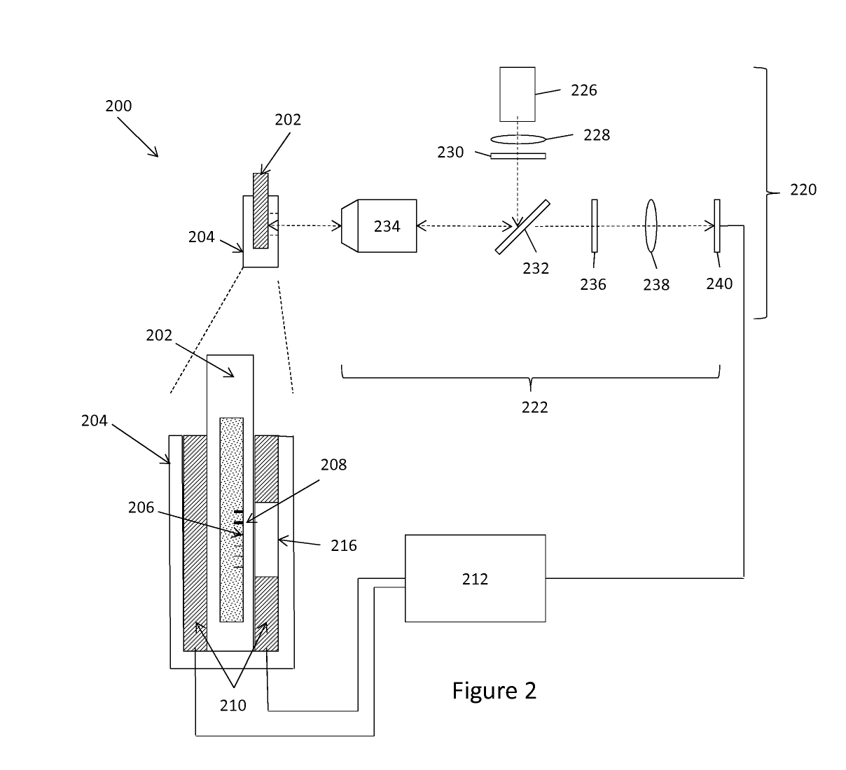

FIG. 2 provides a schematic illustration of an exemplary embodiment of an overall system of the invention. As shown, overall system 200 includes reaction vessel 202 that is reversibly inserted into substrate holder 204. As noted, the reaction vessel typically includes capture probe array 206 integrated upon transparent surface 208 of reaction vessel 202. The substrate holder typically includes appropriate temperature control elements 210 for raising and lowering the temperature applied to reaction vessel 202 in accordance with selected or programmed instructions. Temperature control elements 210 may be controlled by computer or processor 212 that may be integrated into the instrument systems of the invention, along with appropriate user interfaces (not shown in the figure) to allow selection and/or programming of such controls. Alternatively, such programming may be provided by connected processor or computer 212 that is interfaced with the instrument system. In addition, substrate holder 204 also typically includes observation window 216 positioned such that it is coordinated with corresponding transparent surface 208 in reaction vessel 202 when the reaction vessel is inserted in the substrate holder 204.

The instrument portion, portion 220, of overall system 200 includes fluorescent detection optics 222 for gathering and recording fluorescent signals emanating from reaction vessel 202 in substrate holder 204.

As shown, the instrument includes optical train 222 that includes excitation light source 226, such as a laser, laser diode, LED or the like. In operation, light from source 226 is directed through excitation light focusing lens 228 and filter 230 to focus the excitation light and tailor the spectrum of the excitation light for the desired fluorescent analysis, e.g., to excite the fluorophore or fluorophores used to label the components of the assay such as, e.g., a labeled flap probe portion described above. For ease of illustration, the light paths are shown as dashed arrows. The excitation light is then directed upon dichroic mirror 232. Dichroic mirror 232 is configured to reflect the excitation light through objective lens 234 which focuses the light through aperture or observation window 216 in substrate holder 204 and upon reaction vessel 202. Fluorescent signals resulting from excitation of fluorescent reactants within the reaction vessel are then collected by objective lens 234 and passed through dichroic 232, which is configured to reflect the excitation light while passing emitted fluorescent signals of a different wavelength. The fluorescent signals are then passed through emission filter 236, such as a narrow band pass or slot filter, which can be configured to reduce direct reflected excitation light and other light optical noise that was not filtered out by dichroic 232. The filtered fluorescent signals are then passed through emission lens 238 and optionally additional focusing optics (not shown in figure) before they are projected upon image sensor 240. Image sensors of the devices/systems can include any of a variety of suitable sensor arrays, including, e.g., CCDs, EMCCDs, ICCDs, CMOS sensors, and the like. Image sensor 240 is typically connected to appropriate processor electronics, e.g., processor 212 for recording the imaged signals, and analyzing the resulting imaged signals, as described in greater detail below.

### III. Reaction Vessel

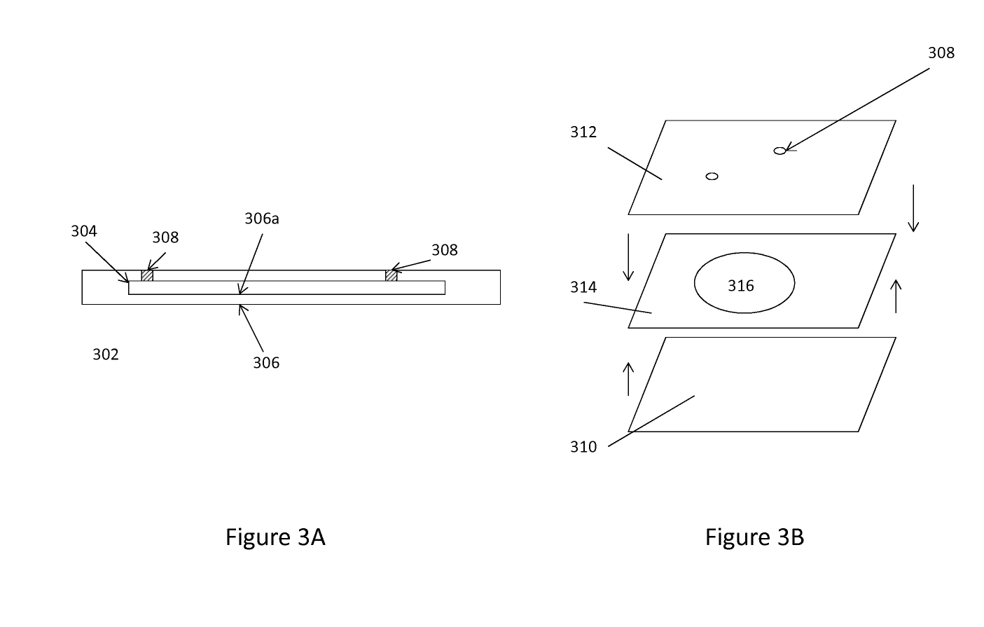

A blown up schematic of an exemplary reaction vessel is shown in FIGS. 3A and 3B. As shown in FIGS. 3A and 3B, reaction vessel 302 includes reaction and detection chamber 304 disposed within its interior. In preferred aspects, the detection chamber includes transparent window portion 306, and preferably includes a nucleic acid array disposed on an interior surface, e.g., surface 306a. As shown, and in preferred aspects, the reaction vessel typically includes a planar geometry and shallow profile above window portion 306, so as to provide reduced background fluorescence levels emanating, e.g., from fluorescently labeled reagents in solution, i.e., not bound to the surface, for those assay formats where it is relevant. Such planar devices are described in, for example, U.S. patent application Ser. No. 13/587,883, previously incorporated herein by reference. Included within the devices shown are one or more reagent ports 308, for introduction of the reagents to the device.

In at least one exemplary aspect, the reaction chamber may include a layered construction as shown in FIG. 3B. As shown, the reaction vessel includes bottom surface layer 310 and upper surface layer 312, that are joined by middle layer 314. Cutout 316 forms a chamber upon assembly of layers 310, 312, and 314. Port(s) 308 form(s) a convenient way to deliver buffer and reagents to the chamber upon assembly. A nucleic acid capture array can be formed on the top or bottom layer in the region that forms the top or bottom surface of cutout 316. In one convenient embodiment, where epifluorescent detection is used for detection of label bound to the array, the array is fabricated on lower surface 310, with the consumable being configured to be viewed by detection optics located in the devices and systems of the invention below the lower surface. Generally, either the top or bottom surface (or both) will include a window through which detection optics can view the array.

### IV. Reaction Vessel Holder

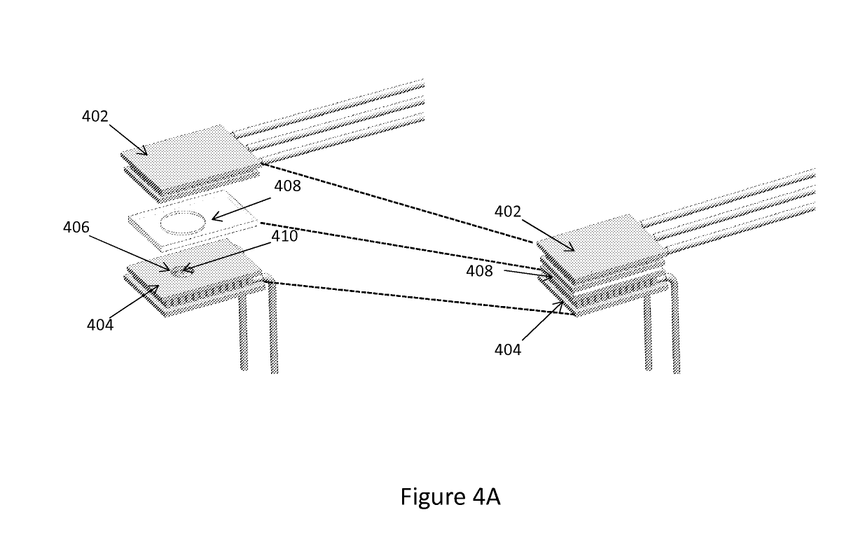

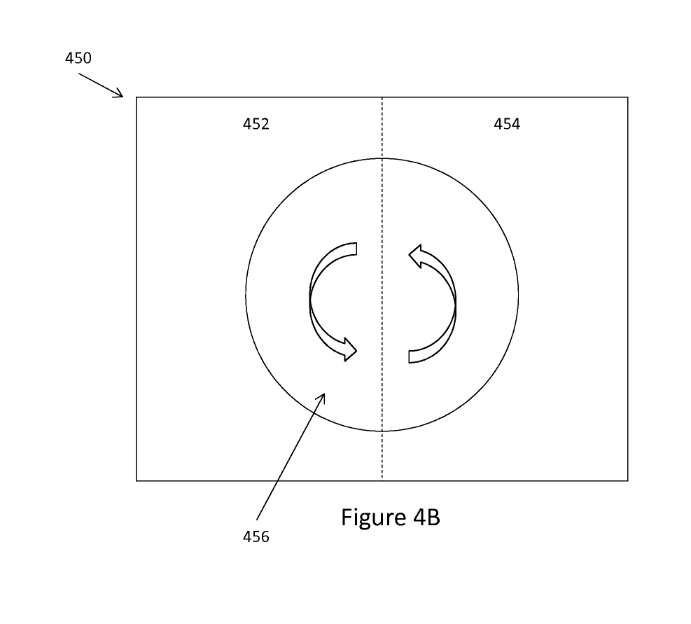

As noted above with reference to FIG. 2, the reaction vessels of the invention can be inserted into reaction vessel or substrate holder portion 204 of instrument system 200. Thermal control of the reaction vessels inserted into substrate holder 204 is carried out through the inclusion of thermal control elements. FIG. 4A provides a schematic illustration of example thermal control elements within the substrate holder portion, to provide thermal management of the amplification reaction within the reaction vessel, e.g., thermal cycling, as well as position and provide optical access to the capture probe array integrated within the reaction vessel.

As shown in the figure, at least two thermal control elements 402 and 404 are disposed within the substrate holder portion and positioned to be able to control the temperature of the reaction vessel and its contents when inserted in the vessel holder, also referred to as being in thermal communication with the reaction vessel. In certain embodiments, a single thermal control element can be included to control the thermal cycling reaction within the reaction vessel. Thermal control elements 402 and 404 are disposed to be in contact or thermal communication with opposing sides of the reaction vessel inserted into the substrate holder portion. These temperature control elements can include any of a variety of different thermal control elements known in the art, but are preferably thermoelectric elements that can be used to both heat and cool the reaction vessel as needed. Providing contact between the reaction vessel and the temperature control elements can be achieved through any of a variety of mechanisms, including a biasing mechanism, clamp, cam spring, or other mechanical element that presses one or both of the reaction vessel and thermal control elements into contact with each other.

Optical access to the reaction vessel can be provided by an aperture disposed through at least one side of the substrate holder, as described above. Complementary aperture 406 can also be provided through one of thermal control elements 404, to allow optical communication with inserted reaction vessel 408 and its associated probe array. In particularly preferred aspects, aperture 406 that defines the observation window of the substrate holder through thermal control element 404 includes transparent layer 410 disposed across it. In particularly preferred aspects, this transparent layer is comprised of a transparent material having a very high thermal conductivity, so as to not interfere with the operation of the thermal control element, while having very low autofluorescence. As a result, the transparent window is both capable of withstanding the constant and wide variations in temperature, as well as allowing for rapid heat transfer to and from the reaction vessel. In some aspects, the transparent material has a thermal conductivity of greater than 1 W/mK, preferably greater than 5 W/mK, and more preferably, greater than 10 W/mK, and in some cases greater than 100 W/mK or even 500 W/mK. Examples of particularly useful transparent materials include for example, sapphire and diamond which have thermal conductivities of approximately 36 and 1000 W/mK, respectively, while other useful transparent materials like crystalline quartz, spinel (MgAl2O4) and ALON have thermal conductivities greater than 5 W/mK and can also be used in the embodiments herein. In some cases, the thermally conductive transparent window is disposed only across the aperture in the thermal control element, while in other cases, it can be provided as an entire layer over the thermal control element.

Certain embodiments can comprise a small gap between the thermally conductive window and the reaction vessel when it is inserted into the substrate holder, in order to prevent optical interference at the interface of the window and the reaction vessel. In particular, a gap of between 1 and 50 microns can be provided, to provide sufficient distance to avoid optical interference, while not creating such distance that it creates a significant insulating layer between the substrate and the thermally conductive window. Generally, the width of the gap needed to avoid interference fringes will be approximately the coherence length or longer of the light passing through it. This coherence length is dependent upon the wavelength and light bandwidth, and can be calculated as wavelength²/Bandwidth for a Gaussian distribution; see for example, Marion and Heald, Classical Electrodynamic Radiation, second edition (Academic Press, New York), 1980.

In certain embodiments, the thermal control elements are configured to provide enhanced heating and convective mixing within the reaction vessel during the amplification process. In particular, for nucleic array based assays where hybridization of a fluid borne nucleic acid to an array bound capture probe is to be detected, one of the process rate limiting steps is the rate at which the solution probes diffuse to and hybridize with the array probes. Many approaches have been described for accelerating these processes, including using magnetic particles or electrophoretic strategies to pull nucleic acids to the surface of the array and thereby the hybridization step. In many cases, sufficient contact can be achieved by simply mixing the fluids that are disposed over the array, which increases the rate at which the fluid borne nucleic acids come into sufficient proximity or contact with the array probes. While simple array systems can do this through the incorporation of mixing elements in the array chamber, or by simply pumping fluid into and out of the chamber, for the reaction vessels of the invention, these methods are less desirable. Accordingly, a convective mixing process is employed in particular embodiments herein.

An exemplary configuration for achieving this convective mixing is illustrated in FIG. 4B. As shown, the thermal control elements disposed within the substrate holder can be configured to provide a thermal profile to the reaction chamber that causes convective mixing within the reaction chamber. In particular, by providing a subset of the thermal control elements at a relatively cooler temperature than another thermal control element, one can drive convective mixing within the reaction chamber. For example, with reference to FIG. 2, each of thermal control elements 210 may be maintained at different temperatures from each other to drive convective mixing within reaction chamber. Alternatively, as shown in FIG. 4B, at least one of the thermal control elements (shown as thermal control element 450), includes two differently controlled portions 452 and 454, to apply a differential temperature across at least a portion of the reaction vessel, e.g., a cooler portion and a warmer portion. The other thermal control element can be likewise configured or it may provide a constant temperature. To drive convective mixing, portion 452 is provided at a cooler temperature from 454 to drive convective mixing as shown by the arrows in reaction chamber 456. This discontinuous heating profile applied to the reaction chamber drives convective mixing of fluids within the reaction vessel.

The convective mixing processes are generally applied to the reaction mixture after liquid is added to the reaction chamber but prior to thermal cycling steps, e.g. to aid in the rapid dissolution and distribution of reagents dried in the reaction chamber, and/or between thermal cycling steps, e.g., during hybridization steps where the reaction is cooled to allow hybridization of the amplification products (i.e., amplicons), to the capture probes on the array.

As noted previously, the instrument systems of the invention typically include processor components for one or both of processing signals collected from the reaction vessel, as well as controlling the thermal control elements in accordance with desired temperature profiles. For example, in the context of preferred PCR amplification reactions carried out within these instrument systems, the processors can include programming to drive the thermal control elements to apply amplification thermal cycling profiles to the reaction vessel and its contents. Such thermal profiles typically include a denaturation step during which the reaction mixture is heated to, e.g., 95° C., to separate hybridized complementary nucleic acid strands of the target, followed by an annealing and extension step where the reaction is cooled to the point where primer sequences may hybridize to the target sequence and the polymerase enzyme may extend the primer along the target, e.g., 45-60° C. This temperature profile can be repeated for several cycles to amplify the underlying target sequence. Accordingly, the systems of the invention can include programming for implementing these thermal cycling profiles. Examples of such profiles are described in, e.g., co-pending U.S. Provisional patent application Ser. No. 13/399,872, filed Feb. 17, 2012, and U.S. Ser. No. 13/587,883, filed Aug. 16, 2012, previously incorporated herein. In addition, the processors can also include programming to drive the differential temperature profiles to different portions of the one or more thermal control elements, or different temperatures to each of at least two different thermal control elements, in order to drive connective mixing of reactants in the reaction vessel, e.g., amplicon mixing. The processors may also include programming for receiving and analyzing the signal data received from the array on the image sensor, e.g., identifying positive signals, and correlating those to a given target sequence presence in the originating sample material.

### V. Focusing Optics

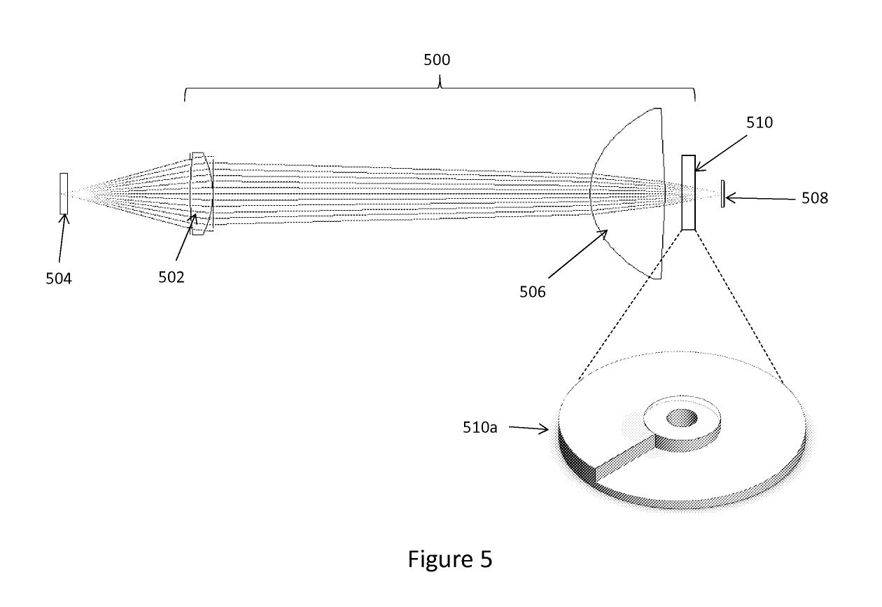

As noted above, the optical train of the overall instrument system also typically includes focusing optics, in order to focus an image of the fluorescent signals from the reaction vessel upon the image sensor. In some embodiments, a simplified optics train is preferred for simplicity and cost. In particular, and as shown in FIG. 5, optics train 500 includes two main focusing lenses: objective lens 502 for collecting fluorescent signals from the array within reaction vessel 504 and directing excitation light upon the array, and focusing lens 506 to focus the image of the fluorescent signals from the array onto imaging sensor 508. In order to provide a simpler and more cost efficient instrument system, these lenses are preferably provided in a fixed configuration relative to each other and each of reaction vessel 504 and image sensor 508. In order to provide fine focus adjustment, optical path length adjustment component 510 is provided within the optical path. By providing a variable optical path length, one can adjust the focal plane of the image on image sensor 508.

It has previously been disclosed that one can adjust the optical path length by introducing one or more wedge prisms translated perpendicular to an optical axis in order to induce an optical path length difference that corrects the focus of an optical system. See, for example the 1941 patent, “Variable Focus System for Optical Instruments,” (Mitchell, U.S. Pat. No. 2,258,903). Similarly, stepped wedge prisms have also been used to introduce discrete changes in the optical path length of a system (see, for example, U.S. Pat. No. 5,040,872, entitled “Beam Splitter/Combiner with Path Length Compensator” to Steinle). In other cases, the optical path length of a dielectric medium (e.g. a window of glass or plastic) is different from free space (i.e. air) by the amount (d/n0−d/n1), where n0 is the refractive index of a free space (˜1), and n1 is the refractive index of the medium (e.g. ˜1.5 for plastic). Examples would be retardation plates and compensators. Any of the foregoing elements constitutes an optical path length adjustment component and can optionally be present in the various embodiments herein.

In the context of the instrument systems described herein, the optical path adjustment component can be selected to provide simple and cost effective components. In particular, preferred systems include a path length adjustment component that comprises a rotatable variable thickness disk positioned in the optical path. By rotating the disk, one introduces thicker portions of the disk into the optical path and consequently increases the optical path length. The disk is rotated until the optimal image focus is achieved. An expanded view of variable thickness disk 510a as the adjustable optical path length component 510 is also shown in FIG. 5. The optical path length adjusting component, e.g., the rotatable variable thickness disk comprises a transparent material and can optionally be fabricated from any of a variety of optical materials, such as glass, quartz, fused silica, and transparent polymers, such as polymethylmethacrylate, poly(carbonate), poly(styrene), poly(ethersulfone), poly(aliphatic ether), halogenated poly(aliphatic ether), poly(aryl ether), halogenated poly(aryl ether), poly(amide), poly(imide), poly(ester)poly(acrylate), poly(methacrylate), poly(olefin), halogenated poly(olefin), poly(cyclic olefin), halogenated poly(cyclic olefin), or poly(vinyl alcohol).

### Examples

The following examples are offered to illustrate, but not necessarily to limit the claimed invention. It is understood that the examples and embodiments described herein are for illustrative purposes only and that various modifications or changes in light thereof will be suggested to persons skilled in the art and are to be included within the spirit and purview of this application and scope of the appended claims.

### In Situ Convective Mixing of Reaction Components

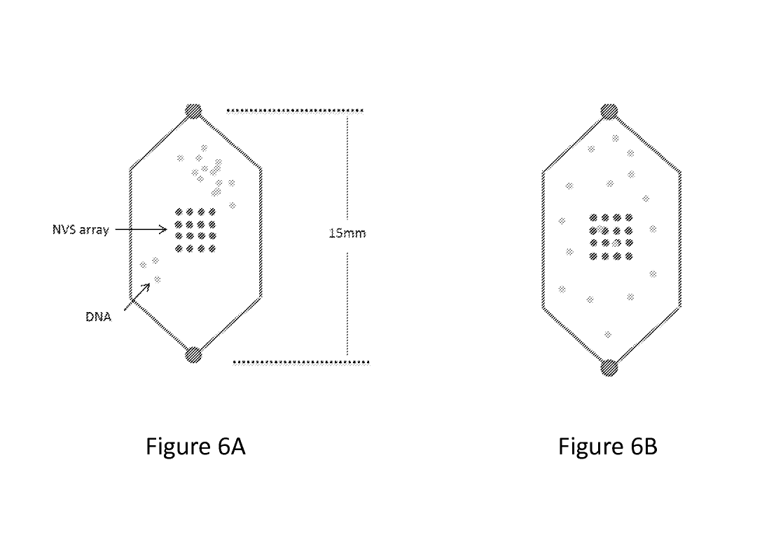

As noted above, in order to obtain higher sensitivity for array based assays where one is detecting hybridization of a fluid borne nucleic acid, e.g., fluorescently labeled flap probes, labeled amplicons, or the like, to a surface bound capture probe, it is preferable to be able to actively mix and transport the fluid borne nucleic acids to the array surface. FIG. 6A depicts a scenario where the detection chamber relies only on molecular diffusion for the transport. In case of low target copy number, there is a high probability that the amplicons will not hybridize to the array within an acceptable timeframe. With mixing, however, amplicons are uniformly distributed inside the chamber (FIG. 6B), therefore increasing the probability of nucleic acids interacting with and hybridizing to the surface of the array.

To test the effect of mixing on PCR sensitivity, a standard assay was performed where test sample having a known target nucleic acid (100 copies of H3 DNA) was amplified in the presence of a flap probe containing target specific nucleic acid probe, e.g., as described above. During the amplification process, a mixing step was introduced between cycle 9 and cycle 10 of the amplification reaction. Simultaneously a control was performed where there was no mixing between cycle 9 and cycle 10. A total of 16 duplicate split PCR reactions were performed. As shown in the table below, the PCR runs with mixing gave much tighter distribution of threshold cycle (Ct) from run to run.

| | With Mixing | No mixing |
|---|---|---|
| Cₜ | 32.96 | 33.45 |
| Std dev | 0.31 | 2.04 |

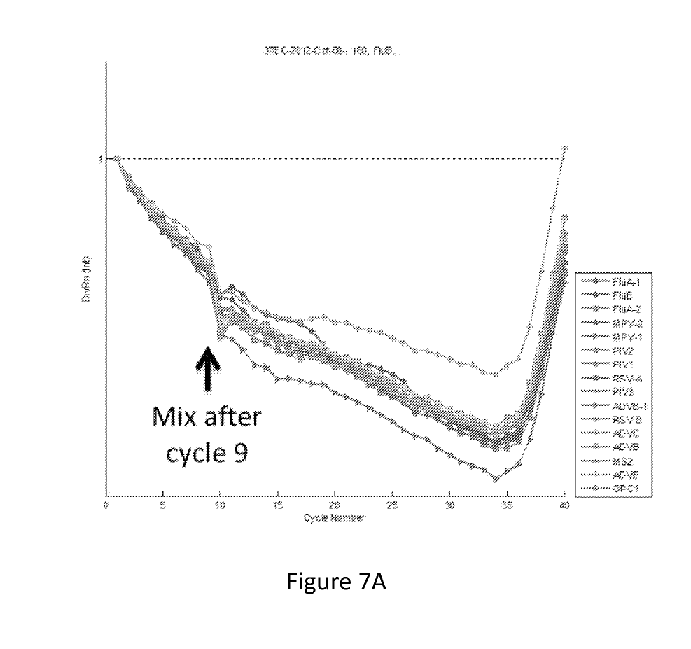

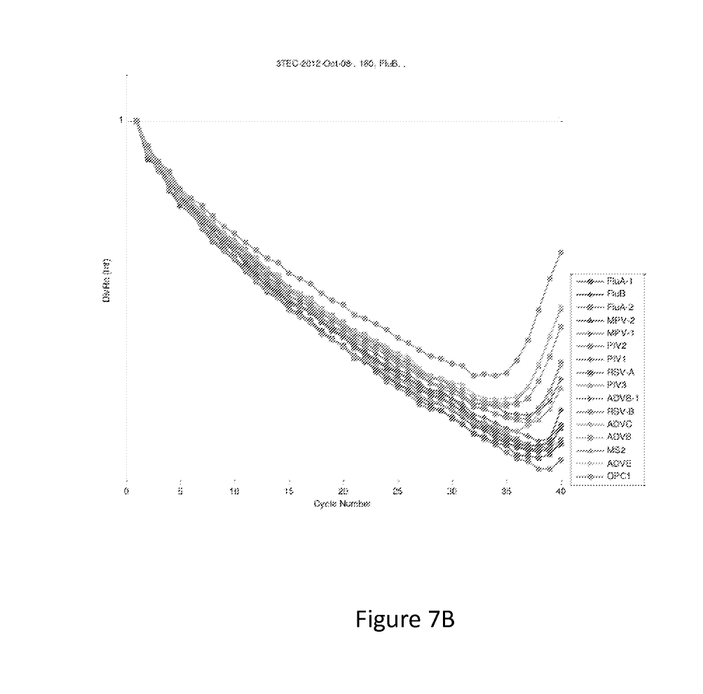

The experiment was repeated using 100 copies of FluB target DNA. Split reactions were again run with either mixing or no mixing. In this case, all the spots in the array were spotted with the FluB capture probe. As a result, ideally all spots should provide signal following amplification. In the case with mixing (FIG. 7A), all the spots came up around the same Ct and deltaRn indicating a uniformly distributed amplicon. However, when active mixing was not invoked, as shown in FIG. 7B, there was a much larger spread of Ct and deltaRn, while some spots on the array did not show any signal. Such results thus indicate a wide concentration range of amplicons on the array, some of which were below the limit of detection.

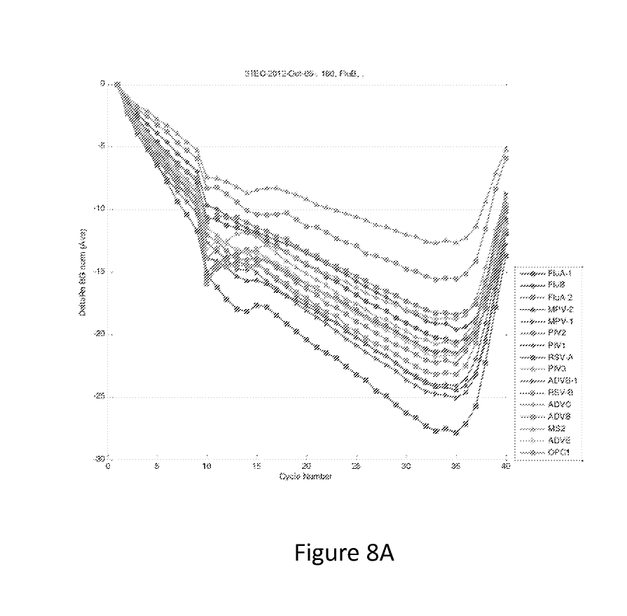

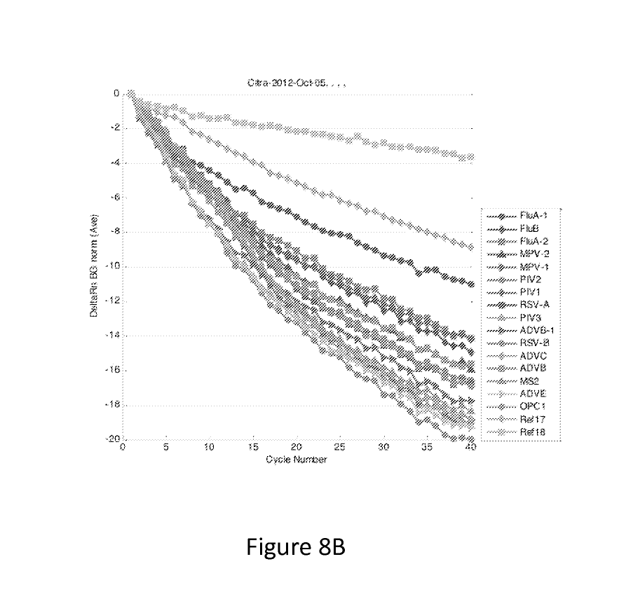

Repeating the above experiment resulted in even more dramatic differences, where the splits that included no mixing between cycles 9 and 10 resulted in no detectable amplicon on the array surface, while the mixed sample showed very good signal. These results are shown in FIGS. 8A (mixing) and 8B (no mixing).

### Convection Mixing of Reagent Components

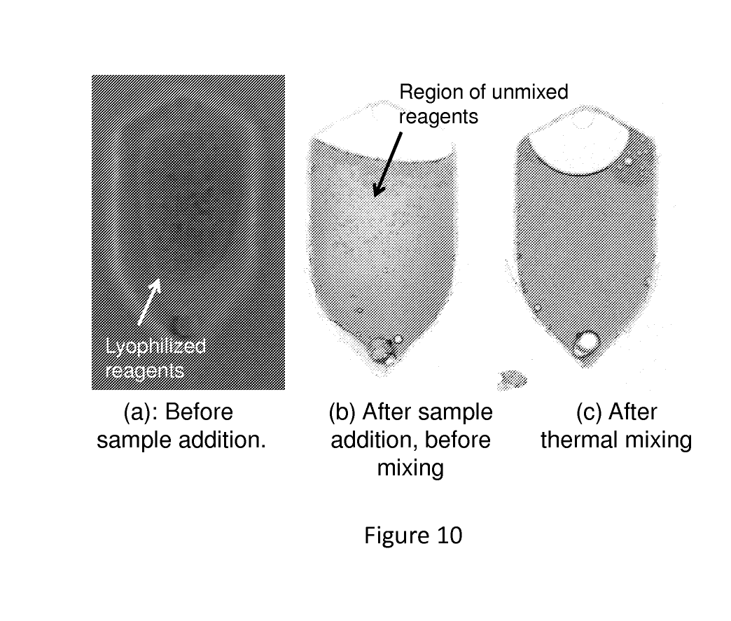

In some embodiments of the invention, the detection or reaction vessel of the system can contain lyophilized reagents, etc. For instance, the lyophilized reagents can contain the enzymes, nucleotides, salts and other reagents that are necessary for reverse transcription (RT) and PCR. Before RT and PCR can occur, it is useful to achieve uniform, homogenous distribution of reagents and sample in the detection vessel. To achieve such homogenous distribution, as illustrated in FIG. 10, some embodiments of the invention use thermal mixing via a three TEC temperature controller configuration.

FIG. 10 shows exemplary use of thermal mixing to reconstitute and homogenize lyophilized reagents with a sample, e.g., as within a system of the invention. FIG. 10a shows the image of a detection vessel (600 um deep, 7 mm wide and 12 mm long). The vessel contained lyophilized RT-PCR reagents. FIG. 10b shows the image after sample has been added, but before the reagents, etc. have been mixed. It can be seen that there is incomplete mixing of the reagents and the sample within the vessel (evident from the bright lighter colored patch in the center). However, after thermal mixing, as can be seen in FIG. 10c, the liquid is uniformly mixed (evident from the uniform color throughout the vessel). For mixing, in this example the temperature controllers, TEC1, TEC2, TEC3 were set at 70, 30, and 30° C. respectively for two minutes.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually and separately indicated to be incorporated by reference for all purposes.

What is claimed is:

1. A detection system, comprising:
an excitation light source;
a reaction vessel comprising an array of capture probe sites disposed thereon, the array producing one or more fluorescent signals in response to the excitation light;
an image sensor;
an optical train for transmitting excitation light from the excitation light source to the array, and fluorescent signals from the array to the image sensor;
one or more thermal control elements disposed in thermal communication with the reaction vessel; and
a processor operably coupled to the one or more thermal control elements, for subjecting contents of the reaction vessel to a thermal cycling profile.

2. The system of claim 1, wherein the optical train includes a focusing lens for focusing the fluorescent signals onto the image sensor, and an optical path length adjustment component between the focusing lens and the image sensor.

3. The system of claim 2, wherein the optical path length adjustment component comprises a rotatable variable thickness disk.

4. The system of claim 3, wherein the rotatable variable thickness disk comprises a transparent material selected from glass, quartz, fused silica, and a transparent polymer.

5. The system of claim 4, wherein the transparent polymer is selected from polymethylmethacrylate, poly(carbonate), poly(styrene), poly(ethersulfone), poly(aliphatic ether), halogenated poly(aliphatic ether), poly(aryl ether), halogenated poly(aryl ether), poly(amide), poly(imide), poly(ester)poly(acrylate), poly(methacrylate), poly(olefin), halogenated poly(olefin), poly(cyclic olefin), halogenated poly(cyclic olefin), and poly(vinyl alcohol).

6. The system of claim 1, wherein at least one thermal control element is a thermoelectric element disposed in an optical path between the excitation light source and the array, the thermal control element having an optical aperture disposed therein, for transmitting the excitation light to the array, the optical aperture comprising a transparent thermally conductive material.

7. The system of claim 6, wherein the transparent thermally conductive material comprises a thermal conductivity of at least 1 W/mK, preferably greater than 5 W/mK, and more preferably, greater than 10 W/mK, and in some cases greater than 100 W/mK or even 500 W/mK

8. The system of claim 6, wherein the transparent thermally conductive material comprises a material selected from glass, sapphire, diamond, crystalline quartz, MgAl2O4 and ALON.

9. The system of claim 6, wherein when the reaction vessel is positioned in thermal communication with the thermal control element having the aperture disposed therethrough, a gap of from about 1 to about 50 microns thick is provided between the optically transparent, thermally conductive material and the reaction vessel.

10. The system of claim 1, wherein the one or more thermal control elements can create different temperature regions within the reaction vessel and thus apply a differential temperature across at least a portion of the reaction vessel.

11. The system of claim 10, wherein the processor includes programming to apply different temperatures to the different temperature regions of the thermal control element.

12. The system of claim 10, wherein the thermal control elements can cause thermal mixing of one or more components within the reaction vessel.

13. A method of detecting an nucleic acid amplification product, comprising:
amplifying a target nucleic acid in a reaction mixture in the presence of a nucleic acid array;
in a hybridization step, cooling the reaction mixture to a hybridization temperature to permit hybridization of the amplification product to the array;
subjecting the reaction mixture to convective mixing before or during the hybridization step; and,
detecting amplification product that hybridizes to the array.
